(19) United States
(12) Patent Application Publication
(10) Pub. No.: US 2007/0263897 A1
(43) Pub. Date: Nov. 15, 2007

(54) Image and Video Quality Measurement

(75) Inventors: Ee Ping Ong, Singapore (SG); Weisi Lin, Singapore (SG); Zhongkang Lu, Singapore (SG); Susu Yao, Singapore (SG); Xiakang Yang, Singapore (SG)

Correspondence Address: FOLEY AND LARDNER LLP;SUITE 500, 3000 K STREET NW, WASHINGTON, DC, 20007, US

(73) Assignee: Agency for Science, Technology and Research, # 07-01 Centros, Singapore (SG)

(21) Appl. No.: 10/583,139

(22) PCT Filed: Dec. 15, 2004
(86) PCT No.: PCT/SG04/00412

§ 371 Date: Apr. 3, 2007

(30) Foreign Application Priority Data
Dec. 16, 2003 (SG) 200307620-5

(51) Int. Cl. G06K 9/00

(52) U.S. Cl. 382/100

(57) ABSTRACT

An image quality measurement system (10) determines various features of an image that relate to the quality of the image in terms of its appearance. The features include the image's blockiness invisibility (B), the image's colour richness (R) and the image's sharpness (S). These are all obtained without the use of a reference image. The determined features are combined to provide an image quality measure (Q).

### FIELD OF THE INVENTION

The present invention relates to the measurement of image and video quality. The invention is particularly useful for, but not necessarily limited to aspects of the measurement of image and video quality without reference to a reference image (“no-reference” quality measurement).

### BACKGROUND ART

Images, whether as individual images, such as photographs, or as a series of images, such as frames of video are increasingly transmitted and stored electronically, whether on home or lap-top computers, hand-held devices such as cameras, mobile telephones, and personal digital assistants (PDAs), or elsewhere.

Although memories are getting larger, there is a continuous quest for reducing images to as little data as possible to reduce transmission time, bandwidth requirements or memory usage. This leads to ever improved intra- and inter-image compression techniques.

Inevitably, most such techniques lead to a loss of data in the de-compressed images. The loss from one compression technique may be acceptable to the human eye or an electronic eye, whilst from another, it may not be. It also varies according to the sampling and quantization amounts chosen in any technique.

To test compression techniques, it is necessary to determine the quality of the end result. That may be achieved by a human judgement, although, as with all things, a more objective, empirical approach may be preferred. However, as the ultimate target for an image is most usually the human eye (and brain), the criteria for determining quality are generally selected according to how much the particular properties or features of a decompressed image or video are noticed.

For instance, distortion caused by compression can be classified as blockiness, blurring, jaggedness, ghost figures, and quantization errors. Blockiness is one of the most annoying types of distortion. Blockiness, also known as the blocking effect, is one of the major disadvantages of block-based coding techniques, such as JPEG or MPEG. It results from intensity discontinuities at the boundaries of adjacent blocks in the decoded image. Blockiness tends to be a result of coarse quantization in DCT-based image compression. On the other hand, the loss or coarse quantization of high frequency components in sub-band-based image compression (such as JPEG-2000 image compression) results in pre-dominant blurring effects.

Various attempts to measure image quality have been proposed. However, in most cases it is with reference to a non-distorted reference image because it is easier to explain quality deterioration with reference to a reference image. Even then, it has been found that it is very difficult to teach a machine to emulate the human vision system, even with a reference image, and it is even more difficult when no reference is available. On the other hand, human observers can easily assess the quality of images without requiring any reference undistorted image/video.

Wang, Z., Sheikh, H. R., and Bovik, A. C., “No-reference perceptual quality assessment of JPEG compressed images”, International Conference on Image Processing, September 2002, proposes a no-reference perceptual quality assessment metric designed for assessing JPEG-compressed images. A blockiness measure and two blurring measures are combined into a single model and the model parameters are estimated by fitting the model to the subjective test data. However, this method does not seem to perform well on images where blockiness is not the predominant distortion.

Wu, H. R. and Yuen, M., “A generalize block-edge impairment metric for video coding, “IEEE Signal Processing Letters., Vol. 4(11), pp. 317-320, 1997, proposes a block-edge impairment metric to measure blocking in images and video without requiring the original image and video as a comparative reference. In this method, a weighted sum of squared pixel gray level differences at 8×8 block boundaries is computed. The weighting function for each block-edge pixel difference is designed using local mean and standard deviations of the gray levels of the pixels to the left and right of the block boundary. Again, this method does not seem to perform well on images where blockiness is not the predominant distortion.

Meesters, L., and Martens, J. B., “A single-ended blockiness measure for JPEG-coded images”, Signal Processing, Vol. 82, 2002, pp. 369-387, proposes a no-reference (single-ended) blockiness measure for measuring the image quality of sequential baseline-coded JPEG images. This method detects and analyses edges based on a Gaussian blurred edge model and uses two separate one-dimensional Hermite transforms along the rows and columns of the image. Then, the unknown edge parameters are estimated from the Hermite coefficients. This method does not seem to perform well on images where blockiness is not the predominant distortion.

Lubin, J., Brill, M. H., and Pica, A. P., “Method and apparatus for estimating video quality without using a reference video”, U.S. Pat. No. 6,285,797, September 2001, proposes a method for estimating digital video quality without using a reference video. This method requires computation of optical flow and specific techniques which include: (1) Extraction of low-amplitude peaks of the Hadamard transform, at code-block periodicities (useful in deciding if there is a broad uniform area with added JPEG-like blockiness); (2) Scintillation detection, useful for determining likely artefacts in the neighbourhood of moving edges; (3) Pyramid and Fourier decomposition of the signal to reveal macroblock artefacts (MPEG-2) and wavelet ringing (MPEG-4). This method is very computationally intensive and time consuming.

Bovik, A. C., and Liu, S., “DCT-domain blind measurement of blocking artifacts in DCT-coded images”, IEEE International Conference on Acoustic, Speech, and Signal Processing, Vol. 3, May 2001, pp. 1725-1728, proposes a method for blind (i.e. no-reference) measurement of blocking artefacts in the DCT-domain. In this approach, a 8×8 block is constituted across any two adjacent 8×8 DCT blocks and the blocking artefact is modelled as a 2-D step function. The amplitude of the 2-D step function is then extracted from the newly constituted block. This value is then scaled by a function of the background activity value and the average value of the block and the final value of all the blocks are combined to give an overall blocking measure. Again, this method does not seem to perform well on images where blockiness is not the predominant distortion.

Wang, Z., Bovik, A. C., and Evans, B. L., “Blind measurement of blocking artifacts in images”, IEEE International Conference on Image Processing, September 2000, pp. 981-984, proposes a method for measuring blocking artefacts in an image without requiring an original reference image. The task here is to detect and evaluate the power of the image. A smoothly varying curve is used to approximate the resulting power spectrum and the powers of the frequency components above this curve are calculated and used to determine a final blockiness measure. Again, this method does not seem to perform well on images where blockiness is not the predominant distortion.

### SUMMARY OF THE INVENTION

According to one aspect of the present invention, there is provided apparatus for determining a measure of image quality of an image. The apparatus includes means for determining a blockiness invisibility measure of the image; means for determining a colour richness measure of the image; means for determining a sharpness measure of the image; and means for providing the measure of image quality of the image based on the blockiness invisibility measure, the colour richness measure and the sharpness measure of the image.

According to a second aspect of the present invention, there is provided apparatus for determining a blockiness invisibility measure of an image. The apparatus comprises: means for averaging differences in colour values at block boundaries within the image; means for averaging differences in colour values between adjacent pixels; and means for providing the blockiness invisibility measure based on averaged differences in colour values between adjacent pixels and averaged differences in colour values at block boundaries within the image.

According to a third aspect of the present invention, there is provided apparatus for determining a colour richness measure of an image. The apparatus comprises: means for determining the probabilities of individual colour values within the image; means for determining the products of the probabilities of individual colour values and the logarithms of the probabilities of individual colour values; and means for providing the colour richness measure based on the sum of the products of the probabilities of individual colour values and the logarithms of the probabilities of individual colour values.

According to a fourth aspect of the present invention, there is provided apparatus for determining a sharpness measure of an image. The apparatus comprises: means for determining differences in colour values between adjacent pixels within the image; means for determining the probabilities of individual colour value differences within the image; means for determining the products of the probabilities of individual colour value differences and the logarithms of the probabilities of individual colour value differences; and means for providing the sharpness measure based on the sum of the products of the probabilities of individual colour value differences and the logarithms of the probabilities of individual colour value differences.

According to a fifth aspect of the present invention, there is provided apparatus for determining a measure of image quality of an image within a sequence of two or more images. The apparatus comprises: apparatus according to the first aspect; and means for determining a motion activity measure of the image within the sequence of images.

According to a sixth aspect of the present invention, there is provided apparatus for determining a motion activity measure of an image within a sequence of two or more images. The apparatus comprises: means for determining differences in colour values between pixels within the image and corresponding pixels in a preceding image within the sequence of images; means for determining the probabilities of individual colour value differences between the image and the preceding image; means for determining the products of the probabilities of individual colour value differences and the logarithms of the probabilities of individual colour value differences; and means for providing the motion activity measure based on the sum of the products of the probabilities of individual colour value differences and the logarithms of the probabilities of individual colour value differences.

According to a seventh aspect of the present invention, there is provided apparatus for determining a measure of video quality of a sequence of two or more images. The apparatus comprises: apparatus according to the first or fifth aspects; and means for providing the measure of video quality based on an average of the image quality for a plurality of images within the sequence of two or more images.

According to an eighth aspect of the present invention, there is provided a method of determining a measure of image quality of an image. The method comprises: determining a blockiness invisibility measure of the image; determining a colour richness measure of the image; determining a sharpness measure of the image; and providing the measure of image quality of the image based on the blockiness invisibility measure, the colour richness measure and the sharpness measure of the image.

According to further aspects of the present invention, there are provided methods corresponding to the second to seventh aspects.

According to yet further aspects of the present invention, there are provided computer program products operable according to the eighth aspect or the further methods and computer program products which when loaded provide apparatus according to the first to seventh aspects.

At least one aspect of the invention is able to provide an image quality measurement system which determines various features of an image that relate to the quality of the image in terms of its appearance. The features may include one or more of: the image's blockiness invisibility, the image's colour richness and the image's sharpness. These may all be obtained without use of a reference image. The one or more determined features, with or without other features, are combined to provide an image quality measure.

### INTRODUCTION TO THE DRAWINGS

The present invention may be further understood from the following description of non-limitative examples, with reference to the accompanying drawings, in which:

FIG. 1 is a block diagram of an image quality measurement system, according to a first embodiment of the invention;

FIG. 2 is a flowchart relating to an exemplary process in the operation of the system of FIG. 1;

FIG. 3 is a flowchart relating to an exemplary process in the operation of one of the features of FIG. 1, which appears as a step of FIG. 2;

FIG. 4 is a flowchart relating to an exemplary process in the operation of another of the features of FIG. 1, which appears as a step of FIG. 2;

FIG. 5 is a flowchart relating to an exemplary process in the operation of again another of the features of FIG. 1, which appears as a step of FIG. 2;

FIG. 6 is a block diagram of a video quality measurement system, according to a second embodiment of the invention;

FIG. 7 is a flowchart relating to an exemplary process in the operation of the system of FIG. 1; and

FIG. 8 is a flowchart relating to an exemplary process in the operation of one of the features of FIG. 6, which appears as a step of FIG. 7.

### DESCRIPTION

Where the same reference numbers appear in more than one Figure, they are being used to refer to the same components and should be understood accordingly.

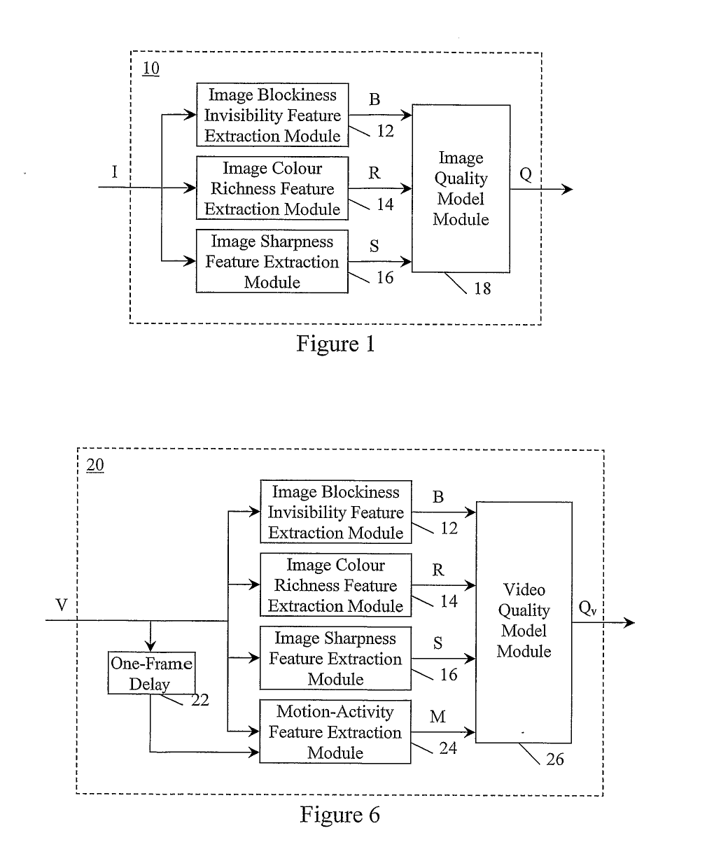

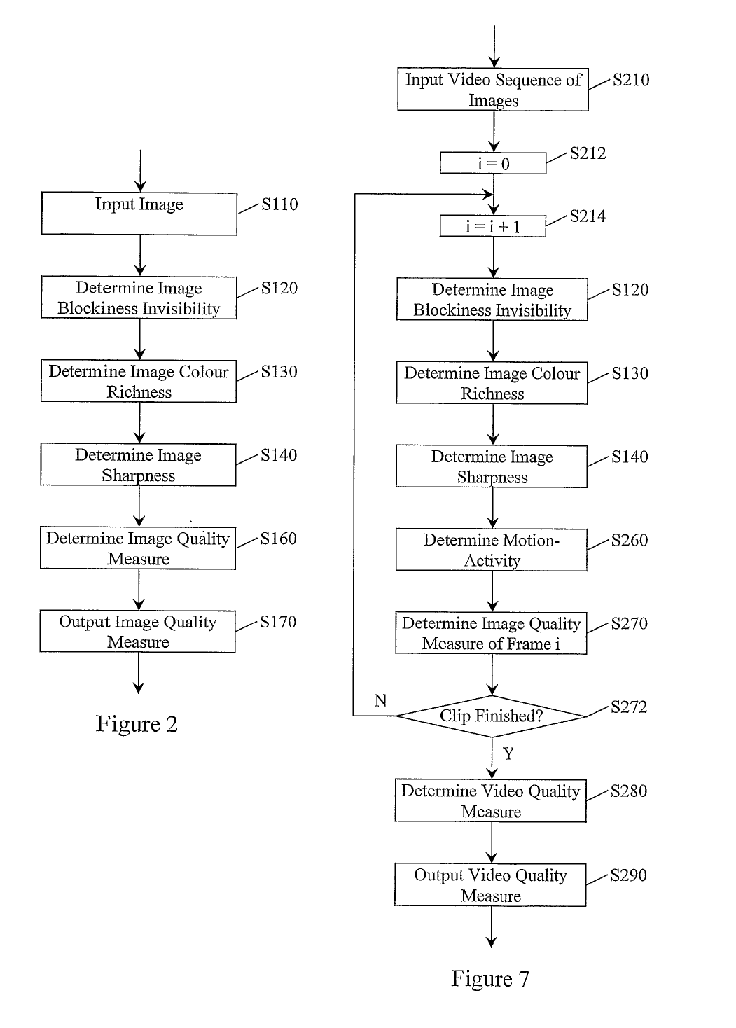

FIG. 1 is a block diagram of an image quality measurement system 10, according to a first embodiment of the invention. An exemplary process in the operation of the system of FIG. 1 is described with reference to FIG. 2.

An image signal I, corresponding to an image whose quality is to be measured, is input (step S110) to an image quality measurement system 10. The image signal I is passed, in parallel, to three modules, an image blockiness invisibility feature extraction module 12, an image colour richness feature extraction module 14 and an image sharpness feature extraction module 16.

Each of these three above-mentioned modules 12, 14, 16 performs a different function on the image signal I to produce its own output signal. The image blockiness invisibility feature extraction module 12 determines a measure of the image blockiness invisibility from the image signal I and outputs a blockiness invisibility measure B (step S120). The image colour richness feature extraction module 14 determines a measure of the image colour richness from the image signal I and outputs an image colour richness measure R (step S130). The image sharpness feature extraction module 16 determines a measure of the image sharpness from the image signal I and outputs an image sharpness measure S (step S140).

The three output signals B, R, S are input together into an image quality model module 18, where they are combined to determine an image quality measure Q (step S160), which is output (step S170).

1(i) Image Blockiness Invisibility Feature Extraction

The image blockiness invisibility feature measures the invisibility of blockiness in an image without requiring a reference undistorted original image for comparison. It contrasts with image blockiness, which measures the visibility of blockiness. Thus, by definition, an image blockiness invisibility measure gives lower values when image blockiness is more severe and more distinctly visible and higher values when image blockiness is very low or does not exist in an image.

The image blockiness invisibility measure, B, is made up of two components, a numerator D and a denominator C, which in turn are made up of 2 separate components measured in both the horizontal x-direction and the vertical y-direction. The horizontal and vertical components of D, labelled Dₕ and Dᵥ, and the horizontal and vertical components of C, labelled Cₕ and Cᵥ, are defined as follows:

$${D}_{h} = \frac{1}{H ( [ W / 8 ] - 1 )} {\sum }_{y = 1}^{H} {\sum }_{x = 1}^{( [ W / 8 ] - 1 )} \vert {d}_{h} ( 8 x , y ) \vert and$$

$${C}_{h} = \frac{1}{HW} {\sum }_{y = 1}^{H} {\sum }_{x = 1}^{W} \vert {d}_{h} ( x , y ) \vert ,$$

where
dₕ(x,y)=I(x+1,y)−I(x,y)

I(x,y) denotes the colour value of the input image I at pixel location (x,y),

H is the height of the image,

W is the width of the image,

x ∈ [1, W], and

y ∈ [1, H].

Similarly,

$${D}_{v} = \frac{1}{W ( [ H / 8 ] - 1 )} {\sum }_{y = 1}^{( [ H / 8 ] - 1 )} {\sum }_{x = 1}^{W} \vert {d}_{v} ( x , 8 y ) \vert , and$$

$${C}_{v} = \frac{1}{HW} {\sum }_{y = 1}^{H} {\sum }_{x = 1}^{W} \vert {d}_{v} ( x , y ) \vert ,$$

where
dᵥ(x,y)=I(x,y+1)−I(x,y).

The horizontal and vertical components of D are computed from block boundaries interspaced 8 pixels apart in the horizontal and vertical directions, respectively.

The blockiness invisibility measure B, composed of 2 separate components Bₕ and Bᵥ, is defined as follows:

$${B}_{h} = \frac{g ( {C}_{h} )}{f ( {D}_{h} )}$$

$${B}_{v} = \frac{g ( {C}_{v} )}{f ( {D}_{v} )}$$

$$B = ( {B}_{h} + {B}_{v} ) / 2$$

A parameterisation of the form:

$${B}_{h} = ( \frac{{C}_{h}^{{γ}_{1}}}{{D}_{h}^{{γ}_{2}}} ) , \\ {B}_{v} = ( \frac{{C}_{v}^{{γ}_{1}}}{{D}_{v}^{{γ}_{2}}} )$$

enables B to correlate closely with human visual subjective ratings. The parameters are obtained by correlating with human visual subjective ratings via an optimisation process such as Hooke and Jeeve's pattern-search method (Hooke R., Jeeve T. A., “Direct Search” solution of numerical and statistical problems, Journal of the associate computing machinery, Vol. 8, 1961, pp. 212-229).

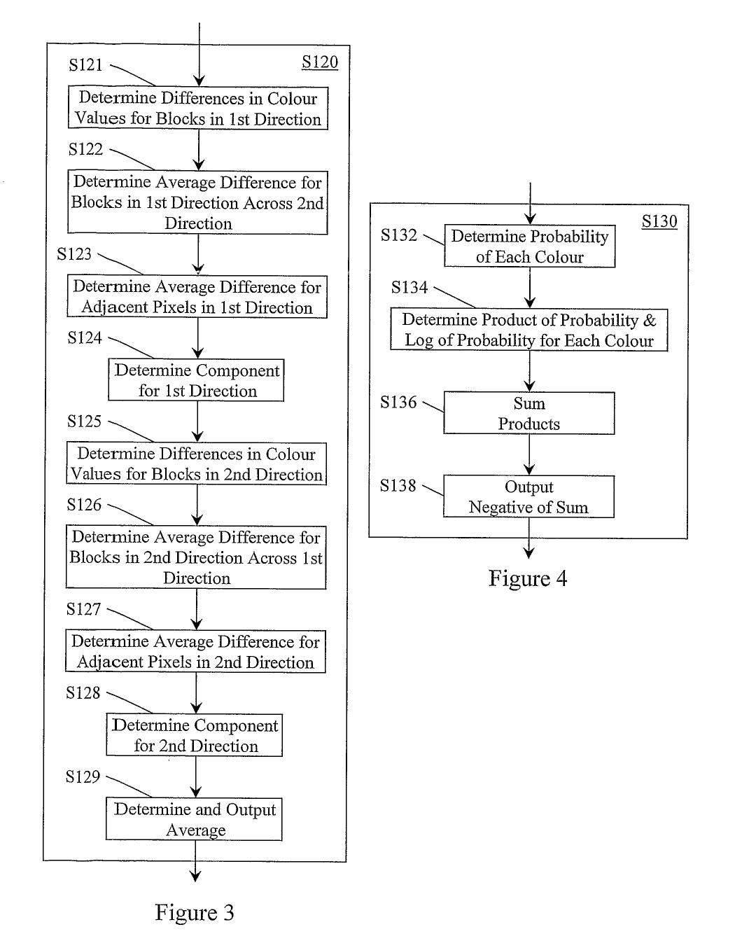

An exemplary process in the operation of the image blockiness invisibility feature extraction module 12 of FIG. 1, which appears as step S120 of FIG. 2, is described with reference to FIG. 3. In this process, for the input image, differences are determined between the colour values of adjacent pixels at block boundaries, in a first direction (step S121). An average difference for every block in the first direction for every layer of pixels in the second direction is determined (step S122). Additionally the average difference between the colour values of adjacent pixels in the first direction for every pixel is determined (step S123). Functions are applied to these two averages for the first direction, from steps S122 and S123, to provide a blockiness invisibility component for the first direction (step S124). For instance the average from step S123 is raised to the power of a first constant, while the average from step 122 is raised to the power of a second constant, and the component is determined as a ratio of the two raised averages.

Differences are also determined between the colour values of adjacent pixels at block boundaries, in the second direction (step S125). An average difference for every block in the second direction for every column of pixels in the first direction, is also determined (step S126). Additionally the average difference between the colour values of adjacent pixels in the first direction for every pixel is determined (step S127). Functions are applied to these two averages for the second direction, from steps S126 and S127, to provide a blockiness invisibility component for the second direction (step S128). For instance the average from step S127 is raised to the power of the first constant, while the average from step 126 is raised to the power of the second constant, and the component is determined as a ratio of the two raised averages.

The blockiness invisibility components for the two directions, from steps S124 and S128, are averaged and the average is output (step S129) as the blockiness invisibility measure B.

1(ii) Image Colour Richness Feature Extraction

The image colour richness feature measures the richness of an image's content. This colour richness measure gives higher values for images which are richer in content (because it is more richly textured or more colourful) compared to images which are very dull and unlively. This feature closely correlates with the human perceptual response which tends to assign better subjective ratings to more lively and more colourful images and lower subjective ratings to dull and unlively images.

The image colour richness measure can be defined as:

$$R = - {\sum }_{p ( i ) ∈ 0} p ( i ) {log}_{e} ( p ( i ) ) ,$$

where

$$p ( i ) = \frac{N ( i )}{{\sum }_{∀ i} N ( i )}$$

i is a particular colour (either the luminance or the chrominance) value,

i ∈ [0,255],

N(i) is the number of occurrence of i in the image, and

p(i) is the probability or relative frequency of i appearing in the image.

This image colour richness measure is a global image-quality feature, computed from an ensemble of colour values' data, based on the sum, for all colour values, of the product of the probability of a particular colour and the logarithm of the probability of the particular colour.

An exemplary process in the operation of the image colour richness feature extraction module 14 of FIG. 1, which appears as step S130 of FIG. 2, is described with reference to FIG. 4. In this process, for the input image, the probability or relative frequency of a colour is determined for each colour within the image (step S132). For each colour a product of the probability of that colour and the natural logarithm of the probability of that colour, is determined (step S134). These products are summed for all colours (step S136), with the negative of that sum is output (step S138) as the image colour richness measure R.

1(iii) Image Sharpness Extraction Feature

The image sharpness feature measures the sharpness of an image's content and assigns lower values to blurred images (due to smoothing or motion-blurring) and higher values to sharp images.

The image sharpness measure has 2 components, Sₕ and Sᵥ, measured in both the horizontal x-direction and the vertical y-direction.

The component of the image sharpness measure in the horizontal x-direction, Sₕ, is defined as:

$${S}_{h} = - {\sum }_{p ( {d}_{h} ) ∉ 0} p ( {d}_{h} ) {log}_{e} ( p ( {d}_{h} ) ) ,$$

where

$$p ( {d}_{h} ) = \frac{N ( {d}_{h} )}{{\sum }_{∀ {d}_{h}} N ( {d}_{h} )} , \\ {d}_{h} ( x , y ) = I ( x + 1 , y ) - I ( x , y ) ,$$

I(x, y) denotes the colour value of the input image I at pixel location (x,y),
H is the height of the image,
W is the width of the image,
x ∈ [1, W],
y ∈ [1, H],
dₕ is the difference values in the horizontal x-direction,
N(dₕ) is the number of occurrences of dₕ among all the difference values in the horizontal x-direction, and
p(dₕ) is the probability or relative frequency of dₕ appearing in the difference values in the horizontal x-direction.

Similarly, the second component of the image sharpness measure in the vertical y-direction, Sᵥ, is defined as:

$${S}_{v} = - {\sum }_{p ( {d}_{v} ) ∉ 0} p ( {d}_{v} ) {log}_{e} ( p ( {d}_{v} ) ) ,$$

where

$$p ( {d}_{v} ) = \frac{N ( {d}_{v} )}{{\sum }_{∀ {d}_{v}} N ( {d}_{v} )}$$

$${d}_{v} ( x , y ) = I ( x , y + 1 ) - I ( x , y )$$

dᵥ is the difference values in the vertical y-direction,
N(dᵥ) is the number of occurrences of dᵥ among all the difference values in the horizontal y-direction, and
p(dᵥ) is the probability or relative frequency of dᵥ appearing in the difference values in the horizontal y-direction.

The image sharpness measure is obtained by combining the horizontal and vertical components, Sₕ and Sᵥ, using the following relationship:
S=(Sₕ+Sᵥ)/2

This image sharpness measure is a global image-quality feature, computed from an ensemble of differences of neighbouring image data, based on the sum, for all differences, of the product of the probability of a particular difference value and the logarithm of the probability of the particular difference value.

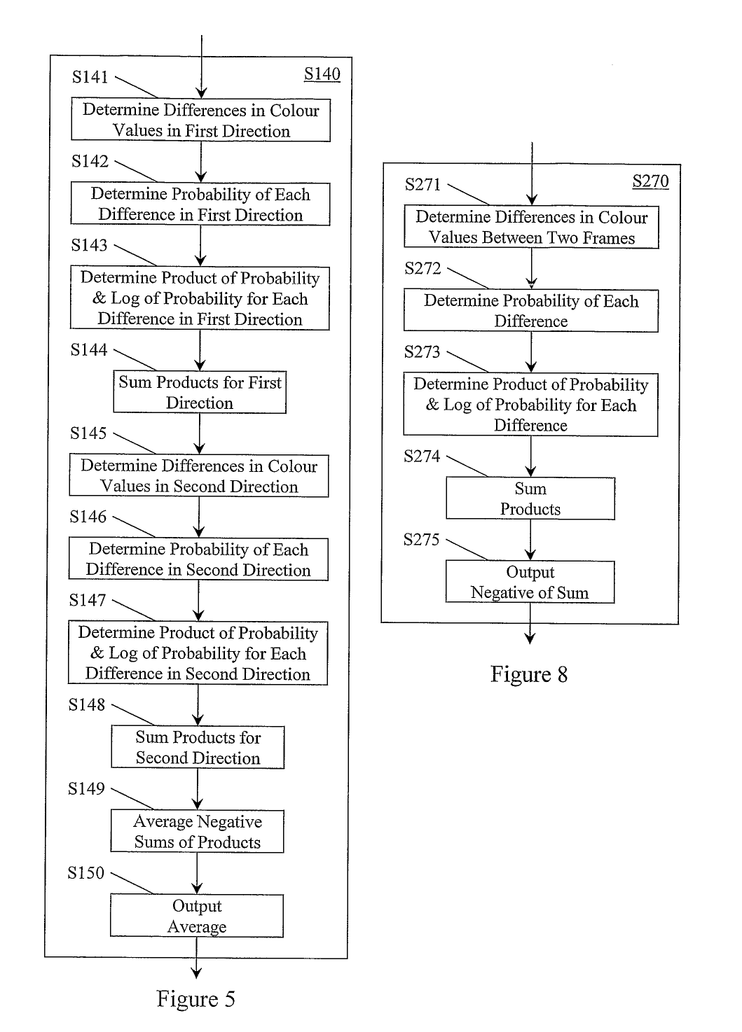

An exemplary process in the operation of the image sharpness feature extraction module 16 of FIG. 1, which appears as step S140 of FIG. 2, is described with reference to FIG. 5. In this process, for the input image, differences are determined between the colour values of adjacent pixels in a first direction (step S141). The probability or relative frequency of each colour value difference in the first direction is determined (step S142). For each colour value difference in the first direction a product of the probability of that difference and the natural logarithm of the probability of that difference, is determined (step S143). These products are summed for all colour value differences in the first direction (step S144). Differences are also determined between the colour values of adjacent pixels in a second direction (step S145). The probability or relative frequency of each colour value difference in the second direction is determined (step S146). For each colour value difference in the second direction a product of the probability of that difference and the natural logarithm of the probability of that difference, is determined (step S147). These products are summed for all colour value differences in the second direction (step S148). The negatives of the two sums, from steps S144 and S148, are averaged (step S149) and the average is output (step S150) as the image sharpness measure S.

1(iv) Image Quality Measurement

The image-quality measures B, R, S are combined into a single model to provide an image quality measure.

An image quality model which has been found to give good results for greyscale images is expressed as:

$$Q = α + β B {S}^{γ 3} + δ {R}^{γ 4} , or as \\ Q = α + β ( ( \frac{{C}_{h}^{γ 1}}{{D}_{h}^{γ 2}} + \frac{{C}_{v}^{γ 1}}{{D}_{v}^{γ 2}} ) / 2 ) {S}^{γ 3} + δ {R}^{γ 4} \qquad ( 1 )$$

The parameters, α, β, γᵢ (for i=1, . . . , 4), and δ are obtained by an optimisation process, such as Hooke and Jeeve's pattern-search method, mentioned earlier, based on the comparison of the values generated by the model and the perceptual image quality ratings obtained in image subjective rating tests so that the model emulates the function of human visual subjective assessment capability.

Thus the quality measure is a sum of three components. The first component is a first constant. The second component is a product of the sharpness measure, S, raised to a first power, the image blockiness invisibility measure, B, and a second constant. The third component is a product of the richness measure, R, raised to a second power, and a third constant.

For colour images, the same algorithm (1) described above is applied to each of the three colour components, luminance Y, and chrominance C_{b} and Cᵣ, separately, and the results are combined as follows to give a combined final image quality score:
Q_{colour}=αQ_{Y}+βQ_{C}_{_{b}}+δQ_{C}_{ᵣ}

These parameters, α, β and δ can similarly be obtained by an optimisation process, based on the comparison of the values generated by the colour model and the perceptual image quality ratings obtained in image subjective rating tests, so that the model emulates the function of human visual subjective assessment capability.

The above image quality model is just one example of a model to combine the image-quality measures to give an image quality measure. Other models are possible instead.

FIG. 6 is a block diagram of a video quality measurement system 20, according to a second embodiment of the invention.

A video signal V, corresponding to a series of video images (frames) whose quality is to be measured, is input to a video quality measurement system 20. The current image of the video signal V passes, in parallel, to a delay unit 22 and to four modules: an image blockiness invisibility feature extraction module 12, an image colour richness feature extraction module 14, an image sharpness feature extraction module 16 and a motion-activity feature extraction module 24.

The delay unit 22 has a delay timing equivalent to one frame, then outputs the delayed image to the motion-activity feature extraction module 24, so that it arrives in parallel with the next image.

The image blockiness invisibility feature extraction module 12, the image colour richness feature extraction module 14 and the image sharpness feature extraction module 16 operate on the input video frame in the same way as on the input image in the embodiment of FIG. 1, to produce similar output signals B, R, S.

The motion-activity feature extraction module 24 determines a measure of the motion-activity feature from the current image of the video signal V and outputs a motion-activity measure M.

The four output signals B, R, S, M are input together into a video quality model module 26, where they are combined to produce a video quality measure Qᵥ.

An exemplary process in the operation of the system of FIG. 6 is described with reference to FIG. 7. The series of images is input into the system 20, one after the other (step S210). A frame count “N” is initiated at “N=0” (step S212). The frame count is then increased by one (i.e. “N=N+1”), in the first pass-through of this step that means this is frame number 1 of the video segment whose quality is being measured.

For the current frame, the process produces the image blockiness invisibility measure B, the image colour richness measure R and the image sharpness measure S (steps S120, S130, S140) in the same way as described with reference to FIGS. 1 to 5. For the current frame, the process also determines a motion-activity measure M, based on the current frame and a preceding frame (in this embodiment it is the immediately preceding frame) (step S260). Image quality for the current frame is then determined in the video quality model module 26 (step S270), based on the image blockiness invisibility measure B, the image colour richness measure R, the image sharpness measure S and the motion-activity measure M for the current frame.

A determination is made as to whether the incoming video clip, or the portion of video whose quality is to be measured has finished (step S272). If it has not finished, the process returns to step S214 and the next frame becomes the current frame. If it is determined at step S272 that there are no more frames to process, the image quality results from the individual frames are used to determine the video quality measure (step S280) for the video sequence, which video quality measure is then output (step S290).

2(i) Motion-Activity Feature Extraction

The motion-activity feature measures the contribution of the motion in the video to the perceived image quality.

The motion-activity measure, M, is defined as follows:

$$M = - {\sum }_{p ( {d}_{f} ) ∉ 0} p ( {d}_{f} ) {log}_{e} ( p ( {d}_{f} ) ) ,$$

where

$$p ( {d}_{f} ) = \frac{N ( {d}_{f} )}{{\sum }_{∀ {d}_{f}} N ( {d}_{f} )}$$

$${d}_{f} ( x , y ) = I ( x , y , t ) - I ( x , y , t - 1 )$$

I(x,y,t) is the colour value of the image I at pixel location I(x,y) and at frame t,

I(x,y,t−1) is the colour value of the image I at pixel location (x,y) and at frame t−1,

d_{f} is the frame difference value,

N(d_{f}) is the number of occurrence of d_{f} in the image-pair, and

p(d_{f}) is the probability or relative frequency of d_{f} appearing in the image-pair.

This motion-activity measure is a global video-quality feature computed from an ensemble of colour differences between a pair of consecutive frames, based on the sum, for all differences, of the product of the probability of a particular difference and the logarithm of the probability of the particular difference.

An exemplary process in the operation of the motion-activity extraction module 24 of FIG. 6, which appears as step S270 of FIG. 7, is described with reference to FIG. 8. In this process, for the input current frame and the preceding frame, differences are determined between the colour values of adjacent pixels in time (step S271). The probability or relative frequency of each colour value difference in time is determined (step S272). For each colour value difference in time a product of the probability of that difference and the natural logarithm of the probability of that difference, is determined (step S273). These products are summed for all colour value differences in time (step S274), with the negative of that sum is output (step S275) as the motion-activity measure M.

2(ii) Video Quality Measurement

The motion-activity measure M is incorporated into the video quality model by computing the quality score for each individual image in the video (i.e. image sequence) using the following video quality model:
Qᵥ=α+βBS^{γ1}e^{M}_{_{γ5}}+δR^{γ2}

The motion-activity measure M modulates the blurring effect since it has been observed that when more motion occurs in the video, human eyes tend to be less sensitive to higher blurring effects.

The parameters of the video quality model can be estimated by fitting the model to subjective test data of video sequences, in a similar manner to the approach for the image quality model in the embodiment of FIG. 1.

Video quality measurement is achieved in the second embodiment by determining the quality score Qᵥ of individual images in the image sequence, and then combining the individual image quality scores Qᵥ, to give a single video quality score \tilde{Q} as follows:

$$\tilde{Q} = {\sum }_{∀ i ∈ sequence} {Q}_{v , i} / N ,$$

where N is the total number of frames over which \tilde{Q} is being computed (it is the last score of N at step S214 of FIG. 7).

The above first embodiment is used for measuring image quality of a single image or of a frame in a video sequence, while the second embodiment is used for measuring the overall video quality of a video sequence. The system of the first embodiment may be used to measure video quality by averaging the image quality measures over the number of frames of the video. In effect this is the same as the second embodiment, but without the motion-activity feature extraction module 24 or the motion-activity measure M.

Both the above-described embodiments use two new global no-reference image-quality features suitable for applications in non-reference objective image and video quality measurement systems: (1) image colour richness and (2) image sharpness. Further the second embodiment provides a new global no-reference video-quality feature suitable for applications in no-reference objective video quality measurement systems: (3) motion-activity. In addition, both above embodiments include an improved measure for measuring image blockiness, the image blockiness invisibility feature.

The above-described embodiments provide new formulae to measure visual quality, one for images, using the two new no-reference image-quality features together with the improved measure of the image blockiness, the other for video, using the two new no-reference image-quality features and the new no-reference video-quality feature, together with the improved measure of the image blockiness.

These three new image/video features are unique in that they give values which are related to the perceived visual quality when distortions have been introduced into an original undistorted image (due to various processes such as image/video compressions and various forms of blurring etc). The computation of these image/video features requires the distorted image/video itself without any need for a reference undistorted image/video to be available (hence the term “no-reference”).

The image colour richness feature measures the richness of an image's content and gives more colourful images higher values and dull images lower values. The image sharpness feature measures the sharpness of an image's content and assigns lower values to blurred images (due to smoothing or motion-blurring etc) and higher values to sharp images. The motion-activity feature measures the contribution of the motion in the video to the perceived image quality. The image blockiness invisibility feature provides an improved measure for measuring image blockiness.

The above embodiments are able to qualify images and video correctly, even those that may have been subjected to various forms of distortions, such as various types of image/video compressions (e.g. by JPEG compression based on DCTs or JPEG-2000 compression based on wavelets, etc.) and also various form of blurring (e.g. by smoothing or motion-blurring). The results from the above-described embodiments of image/video quality measurement systems achieve a close correlation with respect to human visual subjective ratings, measured in terms of Pearson correlation or Spearman rank-order correlation.

Although in the above embodiments the various features as described are used in combination, individual ones or two or more of those features may be taken and used independently of the rest, for instance with other features instead. Likewise, additional features may be added to the above described systems.

In the above description, components of the system are described as modules. A module, and in particular its functionality, can be implemented in either hardware or software or both. In the software sense, a module is a process, program, or portion thereof, that usually performs a particular function or related functions. In the hardware sense, a module is a functional hardware unit designed for use with other components or modules. For example, a module may be implemented using discrete electronic components, or it can form a portion of an entire electronic circuit such as an Application Specific Integrated Circuit (ASIC). In a hardware and software sense, a module may be implemented as a processor, for instance a microprocessor, operating or operable according to the software in memory. Numerous other possibilities exist. Those skilled in the art will appreciate that the system can also be implemented as a combination of hardware and software modules.

The above described embodiments are directed toward measuring the quality of an image or video. The embodiments of the invention are able to do so using several variants in implementation. From the above description of a specific embodiment and alternatives, it will be apparent to those skilled in the art that modifications/changes can be made without departing from the scope and spirit of the invention. In addition, the general principles defined herein may be applied to other embodiments and applications without moving away from the scope and spirit of the invention. Consequently, the present invention is not intended to be limited to the embodiments shown, but is to be accorded the widest scope consistent with the principles and features disclosed herein.

1. Apparatus for determining a measure of image quality of an image, comprising:
means for determining a blockiness invisibility measure of the image;
means for determining a colour richness measure of the image;
means for determining a sharpness measure of the image; and
means for providing the measure of image quality of the image based on the blockiness invisibility measure, the colour richness measure and the sharpness measure of the image.

2. Apparatus according to claim 1, wherein the means for determining the colour richness measure of the image is operable to provide the colour richness based on the sum of the products of the probabilities of colour values and the logarithms of those probabilities.

3. Apparatus according to claim 1 or 2, wherein the means for determining the sharpness measure of the image is operable to provide the sharpness based on the sum of the products of the probabilities of differences between neighbouring portions of the image and the logarithms of those probabilities.

4. Apparatus according to claim 3, wherein the differences between neighbouring portions of the image are differences in colour values.

5. Apparatus according to claim 3 or 4, wherein the differences between neighbouring portions of the image are differences in image data between neighbouring pixels.

6. Apparatus for determining a blockiness invisibility measure of an image, comprising:
means for averaging differences in colour values at block boundaries within the image;
means for averaging differences in colour values between adjacent pixels; and
means for providing the blockiness invisibility measure based on averaged differences in colour values between adjacent pixels and averaged differences in colour values at block boundaries within the image.

7. Apparatus for determining a colour richness measure of an image, comprising:
means for determining the probabilities of individual colour values within the image;
means for determining the products of the probabilities of individual colour values and the logarithms of the probabilities of individual colour values; and
means for providing the colour richness measure based on the sum of the products of the probabilities of individual colour values and the logarithms of the probabilities of individual colour values.

8. Apparatus for determining a sharpness measure of an image, comprising:
means for determining differences in colour values between adjacent pixels within the image;
means for determining the probabilities of individual colour value differences within the image;
means for determining the products of the probabilities of individual colour value differences and the logarithms of the probabilities of individual colour value differences; and
means for providing the sharpness measure based on the sum of the products of the probabilities of individual colour value differences and the logarithms of the probabilities of individual colour value differences.

9. Apparatus according to any one of claims 1 to 5, wherein the means for determining a blockiness invisibility measure of the image comprises apparatus according to claim 6.

10. Apparatus according to any one of claims 1 to 5 and 9, wherein the means for determining a colour richness measure of the image comprises apparatus according to claim 7.

11. Apparatus according to any one of claims 1 to 5, 9 and 10, wherein the means for determining a sharpness measure of the image comprises apparatus according to claim 8.

12. Apparatus for determining a measure of image quality of an image within a sequence of two or more images, comprising:
apparatus according to any one of claims 1 to 5 and 9 to 11; and
means for determining a motion activity measure of the image within the sequence of images.

13. Apparatus for determining a motion activity measure of an image within a sequence of two or more images, comprising:
means for determining differences in colour values between pixels within the image and corresponding pixels in a preceding image within the sequence of images;
means for determining the probabilities of individual colour value differences between the image and the preceding image;
means for determining the products of the probabilities of individual colour value differences and the logarithms of the probabilities of individual colour value differences; and
means for providing the motion activity measure based on the sum of the products of the probabilities of individual colour value differences and the logarithms of the probabilities of individual colour value differences.

14. Apparatus according to claim 12, wherein the means for determining a motion activity measure of the image within the sequence of images comprises apparatus according to claim 13.

15. Apparatus according to claim 12 or 14, wherein the means for providing the measure of image quality of the image is operable to provide the image quality measure further based on the motion activity measure of the image.

16. Apparatus for determining a measure of video quality of a sequence of two or more images, comprising:
apparatus according to any one of claims 1 to 5, 9 to 12, 14 and 15; and
means for providing the measure of video quality based on an average of the image quality for a plurality of images within the sequence of two or more images.

17. Apparatus according to any one of the preceding claims, operable to make the determination without reference to a reference image.

18. A method of determining a measure of image quality of an image, comprising:
determining a blockiness invisibility measure of the image;
determining a colour richness measure of the image;
determining a sharpness measure of the image; and
providing the measure of image quality of the image based on the blockiness invisibility measure, the colour richness measure and the sharpness measure of the image.

19. A method according to claim 18, wherein determining the colour richness measure of the image comprises providing the colour richness based on the sum of the products of the probabilities of colour values and the logarithms of those probabilities.

20. A method according to claim 18 or 19, wherein determining the sharpness measure of the image comprises providing the sharpness based on the sum of the products of the probabilities of differences between neighbouring portions of the image and the logarithms of those probabilities.

21. A method according to claim 20, wherein the differences between neighbouring portions of the image are differences in colour values.

22. A method according to claim 20 or 21, wherein the differences between neighbouring portions of the image are differences in image data between neighbouring pixels.

23. A method for determining a blockiness invisibility measure of an image, comprising:
averaging differences in colour values at block boundaries within the image;
averaging differences in colour values between adjacent pixels; and
providing the blockiness invisibility measure based on averaged differences in colour values between adjacent pixels and averaged differences in colour values at block boundaries within the image.

24. A method for determining a colour richness measure of an image, comprising:
determining the probabilities of individual colour values within the image;
determining the products of the probabilities of individual colour values and the logarithms of the probabilities of individual colour values; and
providing the colour richness measure based on the sum of the products of the probabilities of individual colour values and the logarithms of the probabilities of individual colour values.

25. A method for determining a sharpness measure of an image, comprising:
determining differences in colour values between adjacent pixels within the image;
determining the probabilities of individual colour value differences within the image;
determining the products of the probabilities of individual colour value differences and the logarithms of the probabilities of individual colour value differences; and
providing the sharpness measure based on the sum of the products of the probabilities of individual colour value differences and the logarithms of the probabilities of individual colour value differences.

26. A method according to any one of claims 18 to 22, wherein determining a blockiness invisibility measure of the image comprises a method according to claim 23.

27. A method according to any one of claims 18 to 22 and 26, wherein determining a colour richness measure of the image comprises a method according to claim 24.

28. A method according to any one of claims 18 to 22, 26 and 27, wherein determining a sharpness measure of the image comprises a method according to claim 25.

29. A method for determining a measure of image quality of an image within a sequence of two or more images, comprising:
a method according to any one of claims 18 to 22 and 26 to 28; and
determining a motion activity measure of the image within the sequence of images.

30. A method for determining a motion activity measure of an image within a sequence of two or more images, comprising:
determining differences in colour values between pixels within the image and corresponding pixels in a preceding image within the sequence of images;
determining the probabilities of individual colour value differences between the image and the preceding image;
determining the products of the probabilities of individual colour value differences and the logarithms of the probabilities of individual colour value differences; and
providing the motion activity measure based on the sum of the products of the probabilities of individual colour value differences and the logarithms of the probabilities of individual colour value differences.

31. A method according to claim 29, wherein determining a motion activity measure of the image within the sequence of images comprises a method according to claim 29.

32. A method according to claim 29 or 31, wherein providing the measure of image quality of the image comprises providing the image quality measure further based on the motion activity measure of the image.

33. A method for determining a measure of video quality of a sequence of two or more images, comprising:
a method according to any one of claims 18 to 22, 26 to 29, 31 and 32; and
providing the measure of video quality based on an average of the image quality for a plurality of images within the sequence of two or more images.

34. A method according to any one of the claims 18 to 33, wherein the determination is made without reference to a reference image.

35. A method of determining a measure of video or image quality substantially as hereinbefore described with reference to and as illustrated in the accompanying drawings.

36. Apparatus according to any one of claims 1 to 17 operable in accordance with the method of any one of claims 18 to 35.

37. Apparatus for determining a measure of video or image quality constructed and arranged substantially as hereinbefore described with reference to and as illustrated in the accompanying drawings.

38. A computer program product having a computer usable medium having a computer readable program code means embodied therein for determining a measure of video or image quality, the computer program product comprising:
computer readable program code means for operating according to the method of any one of claims 18 to 35.

39. A computer program product having a computer usable medium having a computer readable program code means embodied therein for determining a measure of video or image quality, the computer program product comprising:
computer readable program code means which, when downloaded onto a computer renders the computer into apparatus according to any one of claims 1 to 17, 36 and 37.
